(19) United States
(12) Patent Application Publication
(10) Pub. No.: US 2009/0139916 A1
(43) Pub. Date: Jun. 4, 2009

(54) Filtration device for aquarium

(76) Inventor: Hsueh Lee Tsai, Yunlin Hsien (TW)

Correspondence Address: CHARLES E. BAXLEY, ESQUIRE, 90 JOHN STREET, SUITE 309, NEW YORK, NY, 10038, US

(21) Appl. No.: 11/998,572

(22) Filed: Nov. 30, 2007

(51) Int. Cl. B01D 35/14; B01D 35/143; B01D 35/147

(52) U.S. Cl. 210/87

(57) ABSTRACT

A filtration device includes a carrier for attaching to the aquarium and having a filtering chamber for receiving a water, a filter member disposed in the filtering chamber for filtering the water, and a signal generating device for generating a signal to indicate whether the filter member has been blocked or not or when the filter member may no longer filter the water contained within the container of the aquarium, and for allowing the filter member to be cleaned or changed or replaced by the user right away or when required. A dirt collecting device may be used to collect the dirt carried by the upwardly flowing bubbles.

### BACKGROUND OF THE INVENTION

1. Field of the Invention

The present invention relates to a filtration device for an aquarium, and more particularly to a filtration device for attaching to an aquarium and for generating a signal to indicate that the filter members or devices have been blocked or when the filter members or devices may no longer filter the water contained within the container of the aquarium, and for allowing the filter members or devices to be cleaned or changed or replaced by the user when required.

2. Description of the Prior Art

Typical aquarium facilities comprise a pump disposed in a chamber of a container for circulating the water contained within the container and for pumping fresh air or carbon dioxide into the container and thus for airing or aerating purposes, and one or more filter members or devices also disposed in the chamber of the container for filtering the water.

For example, U.S. Pat. No. 5,011,600 to Mowka, Jr., et al., U.S. Pat. No. 5,059,315 to Senape, and U.S. Pat. No. 5,169,520 to Wang disclose three of the typical aquariums each also having an air pumping device for pumping or impelling the water, and one or more filter members or devices disposed in the aquarium for filtering the water.

However, after use, the filter members or devices may have a good chance to be blocked by the dirt and/or the protein or the other contaminant contained in the water, and may no longer be used to filter the water that is received within the container, and the user may not know whether the filter members or devices are blocked or not and may not clean or change or replace the filter members or devices when required.

The present invention has arisen to mitigate and/or obviate the afore-described disadvantages of the conventional water filtering assemblies for aquarium facilities.

### SUMMARY OF THE INVENTION

The primary objective of the present invention is to provide a filtration device for attaching to an aquarium and for generating a signal to indicate that the filter members or devices have been blocked or when the filter members or devices may no longer filter the water contained within the container of the aquarium, and for allowing the filter members or devices to be cleaned or changed or replaced by the user when required.

In accordance with one aspect of the invention, there is provided a filtration device for an aquarium comprising a carrier for attaching to the aquarium and including a filtering chamber formed therein for receiving a water, a filter member disposed in the filtering chamber for filtering the water, and a signal generating device for generating a signal to indicate whether the filter member has been blocked or not.

The carrier includes a pathway formed therein, the signal generating device includes a check valve for selectively blocking the pathway of the carrier and for being selectively actuated by the water to open the pathway of the carrier when the filter member is blocked.

The check valve includes a protrusion extended form the check valve. The carrier includes a cover having a hole formed therein, and the protrusion is extendible through the hole of the cover for indicating that the check valve has been actuated.

The carrier includes an upper panel, and the pathway is formed in the upper panel of the carrier. The carrier includes a partition disposed in the filtering chamber of the carrier for spacing the filtering chamber of the carrier into a first space and a second space, and the filter member is disposed in the first space of the carrier, and the upper panel is disposed for closing the second space of the carrier.

The carrier includes a compartment formed therein and located beside the filtering chamber of the carrier and communicating with the filtering chamber of the carrier for receiving the water from the filtering chamber of the carrier. The carrier includes a dirt collecting device provided on the compartment of the carrier for collecting the dirt moved upwardly by bubbles.

The dirt collecting device includes a receptacle disposed on the compartment of the carrier for receiving bubbles from the filtering chamber of the carrier. The receptacle includes a tubular member extended in the receptacle for forming a peripheral space between the tubular member and the receptacle, and for forming a passageway within the tubular member which is communicating with the compartment of the carrier for receiving the bubbles which carry the dirt for moving the dirt upwardly over the tubular member. The receptacle includes a casing having a chamber formed therein and communicating with the peripheral space of the receptacle for receiving and collecting the dirt.

The carrier includes a peripheral frame disposed on the compartment of the carrier for slidably engaging with the receptacle. The peripheral frame includes a peripheral flange extended inwardly from the peripheral frame for slidably or adjustably engaging with the receptacle.

The carrier includes an inlet chamber formed therein, and a passage formed between the inlet chamber and the compartment of the carrier, and a barrel disposed in the compartment of the carrier and having a duct communicating the barrel with the passage of the carrier for allowing the water to flow from the inlet chamber into the barrel.

The carrier includes a filtering material disposed in the inlet chamber of the carrier, and a hose engaged into the inlet chamber of the carrier for supplying the water into the inlet chamber of the carrier. An inlet member may further be provided and coupled to the hose. A pumping device may further be provided and coupled to the hose for pumping the water into the hose.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a filtration device for attaching to an aquarium in accordance with the present invention;

FIG. 2 is a partial exploded view of the filtration device;

FIG. 3 is a partial cross sectional view of the filtration device taken along lines 3-3 of FIG. 1;

FIG. 4 is a cross sectional view of the filtration device taken along lines 4-4 of FIG. 3;

FIG. 5 is an enlarged partial cross sectional view illustrating the operation of the filtration device;

FIG. 6 is a partial cross sectional view illustrating the operation of the filtration device;

FIG. 7 is another partial cross sectional view similar to FIG. 6, illustrating the operation of the filtration device; and

FIG. 8 is a further partial cross sectional view of the filtration device illustrating the operation of the filtration device.

### DETAILED DESCRIPTION OF THE PREFERRED EMBODIMENT

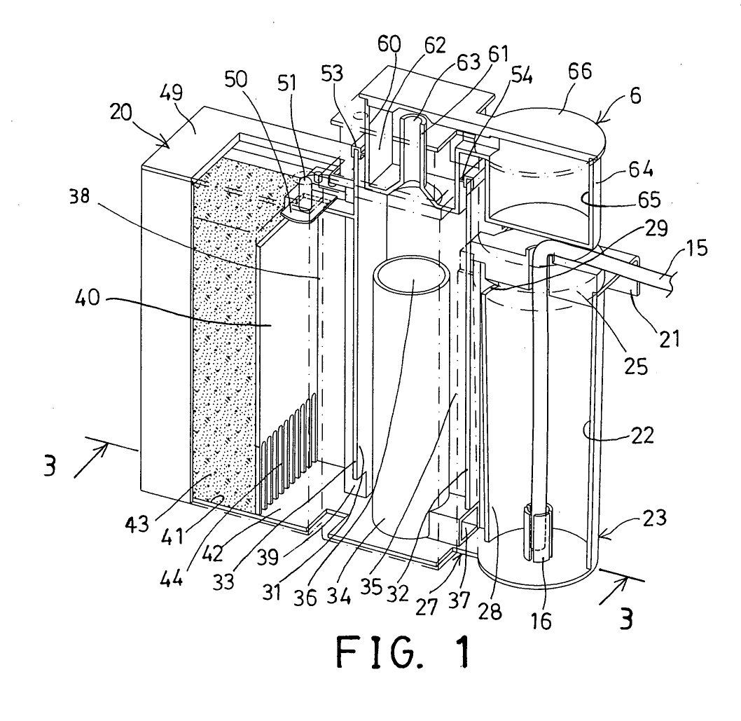

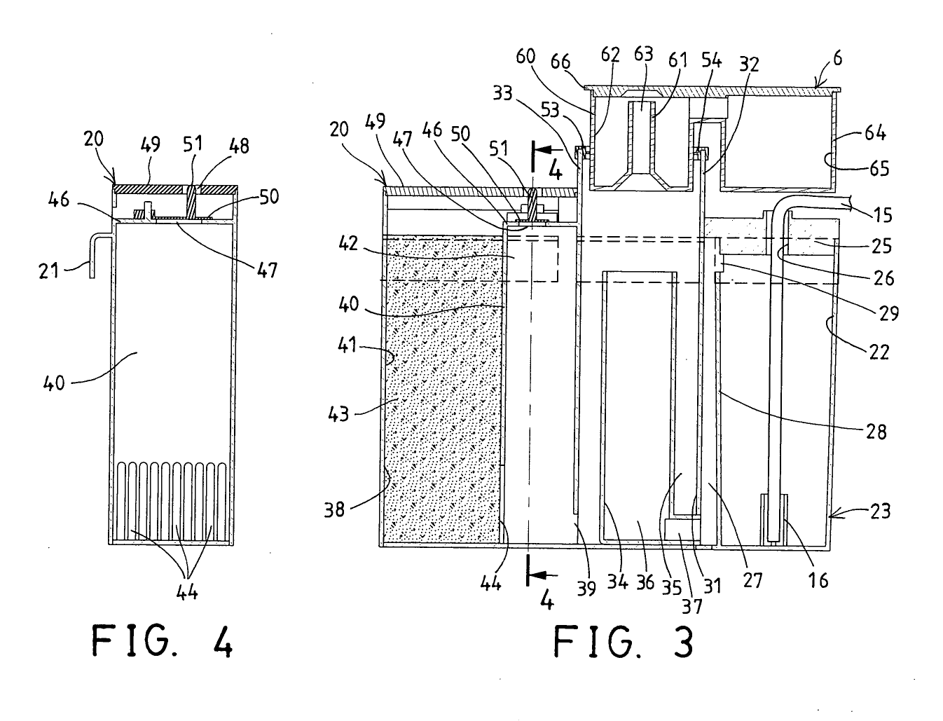

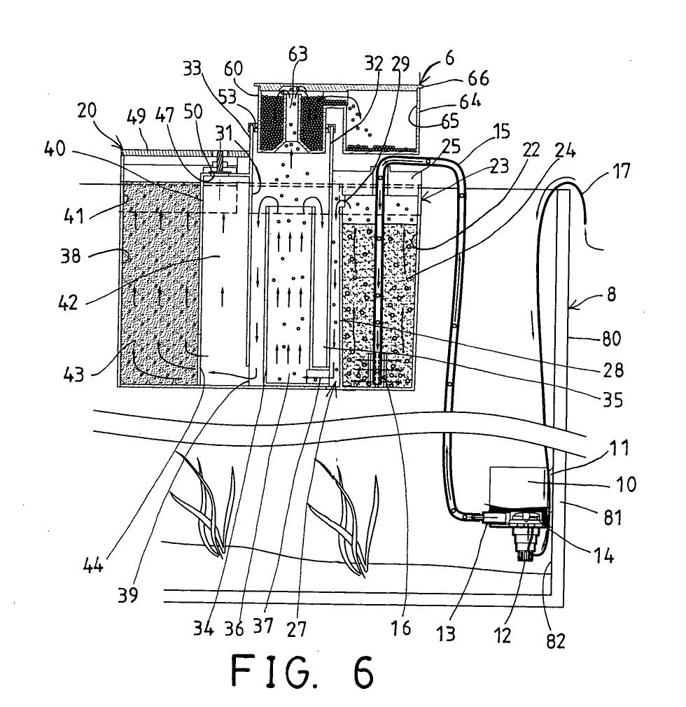

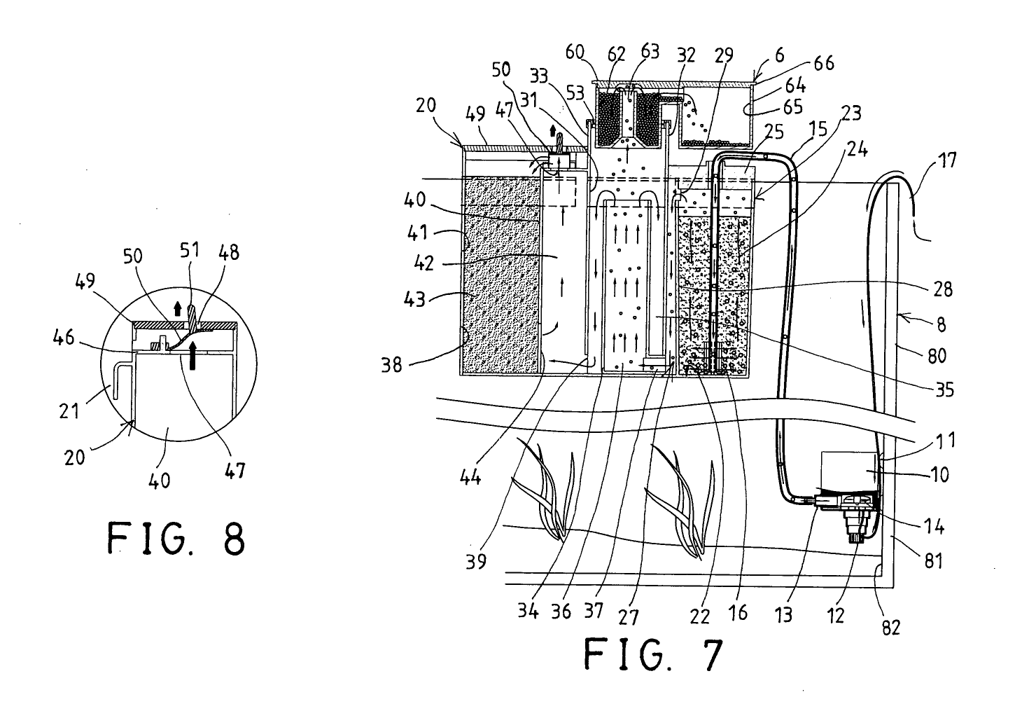

Referring to the drawings, and initially to FIGS. 1-4, a filtration device in accordance with the present invention comprises a pumping device 10 for attaching to a wall 81 or an inner portion of a container 80 of an aquarium 8 (FIGS. 6, 7) with hooks or latches or fasteners (not shown) or sucking cups 11 or the like, and the pumping device 10 includes a water inlet 12 formed or provided in such as the lower portion thereof, and includes a water outlet 13 formed or provided in such as the middle portion thereof, and includes a motorized paddle wheel or paddle device or impeller 14 for pumping the water from the container 80 into the water inlet 12 and out of the water outlet 13 and for circulating the water contained within the container 80 in which the container 80 includes a chamber 82 formed therein for receiving water and fish, and/or water plants.

A hose 15 is coupled to the water outlet 13 of the pumping device 10 for receiving the water pumped or impelled by the powered or motorized impeller 14 and for supplying the water to a carrier 20, and an air stone or inlet member 16 may be optionally or selectively attached or coupled to the inner end of the hose 15 for suitably supplying the water into the carrier 20. An air or gas supplying member 17 may further be provided and coupled to the water inlet 12 of the pumping device 10 for suitably supplying the air or gas, such the fresh air in the outer environment, or the oxygen or the carbon dioxide, etc. into the pumping device 10 for being agitated or pumped or impelled by the powered or motorized impeller 14 and then to flow into the carrier 20.

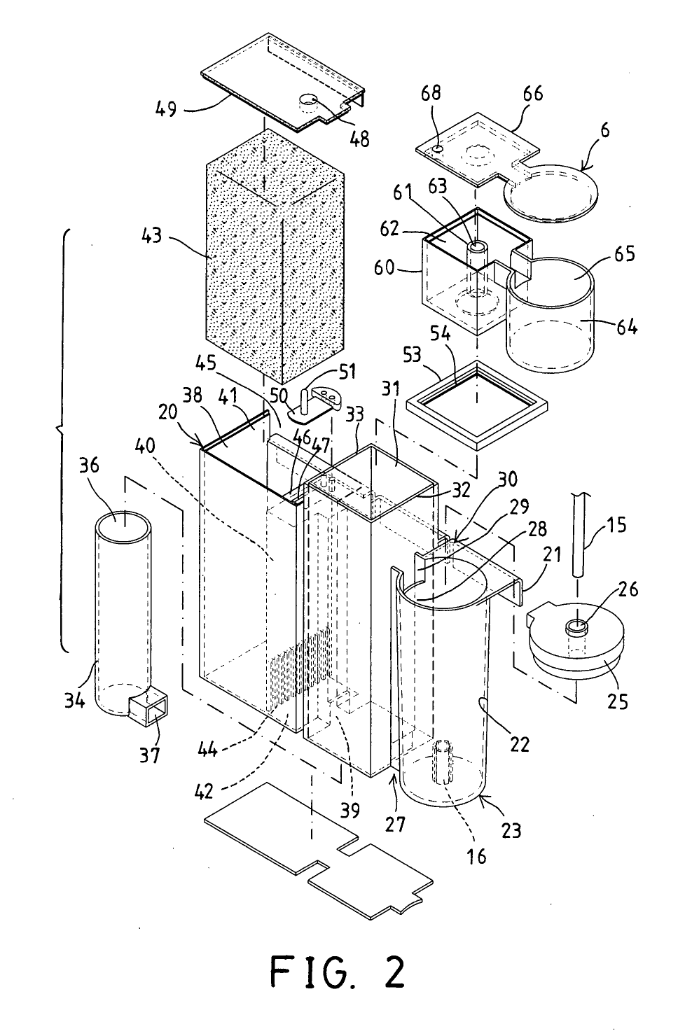

For example, the carrier 20 includes a hook or attaching means or device 21 (FIGS. 1, 2) for readily attaching or hanging onto the wall 81 or the inner portion of the container 80 of the aquarium 8 (FIGS. 6, 7) without latches or fasteners or sucking cups or the like, and includes an inlet chamber 22 formed therein, such as formed in one side 23 thereof for receiving a filtering material 24, such as gravels or stones or sands or the like, and the hose 15 and/or the inlet member 16 is engaged into the lower or bottom portion of the inlet chamber 22 of the carrier 20 for supplying the water into the inlet chamber 22 of the carrier 20 and for allowing the water to flow upwardly through the inlet chamber 22 of the carrier 20 and to be filtered by the filtering material 24.

A cap 25 may be attached to the upper portion of the inlet chamber 22 of the carrier 20 for closing or blocking or sealing the upper portion of the inlet chamber 22 of the carrier 20, and includes an orifice 26 formed therein for engaging with the hose 15 and for allowing the hose 15 to be engaged into the inlet chamber 22 of the carrier 20. The carrier 20 includes a passage 27 formed therein, such as formed or located beside and parallel to the inlet chamber 22 of the carrier 20 and defined by a wall 28, and includes a notch 29 formed or provided in the upper portion 30 of the wall 28 and communicating with the inlet chamber 22 of the carrier 20 for allowing the water to flow through the notch 29 of the wall 28 and to flow into the passage 27 of the carrier 20.

The carrier 20 further includes a compartment 31 formed therein, such as formed or located beside and parallel to the passage 27 of the carrier 20 and defined by or between two walls 32, 33, and includes a barrel 34 disposed in the inner portion of the compartment 31 and spaced from the walls 32, 33 for forming an annular or peripheral space 35 between the barrel 34 and the walls 32, 33, the barrel 34 includes a bore 36 formed therein, and includes a duct 37 formed or provided in the lower portion of the barrel 34 and communicating with the bore 36 of the barrel 34 and the passage 27 of the carrier 20 for allowing the water to flow through the duct 37 and to flow into the lower portion of the barrel 34 and then to flow upwardly through the bore 36 of the barrel 34 and then to flow over the barrel 34 and then to flow into the peripheral space 35 of the carrier 20.

The carrier 20 further includes a filtering chamber 38 formed therein, such as formed or located beside and parallel to the compartment 31 or the barrel 34 of the carrier 20, and includes an opening 39 formed or provided in the lower portion of the wall 33 and communicating with the filtering chamber 38 and the peripheral space 35 of the carrier 20 for allowing the water to flow from the compartment 31 or the peripheral space 35 of the carrier 20 through the opening 39 and to flow into the filtering chamber 38 of the carrier 20. A partition 40 is vertically disposed and engaged into the filtering chamber 38 of the carrier 20 for spacing the filtering chamber 38 of the carrier 20 into two spaces 41, 42, such as a larger or first space 41 and a smaller or second space 42, and a sponge or filter member 43 is disposed in one of the spaces 41 or in the filtering chamber 38 for filtering the water.

The partition 40 includes one or more apertures 44 formed in such as the lower portion of the partition 40 and communicating with the spaces 41, 42 of the carrier 20 for allowing the water from the compartment 31 to flow through the opening 39 and to flow into the filtering chamber 38 of the carrier 20 and then to flow through the apertures 44 of the partition 40 and then to flow upwardly through the larger space 41, and to be filtered by the filter member 43, and to flow out through an outlet port 45 (FIG. 2) of the carrier 20. The carrier 20 further includes an upper panel 46 formed or provided on the upper portion of the smaller space 42 for closing or blocking or sealing the upper portion of the smaller space 42 of the carrier 20, and includes a pathway 47 formed in the upper panel 46 and communicating with the smaller space 42 of the carrier 20.

A spring blade or check valve 50 is attached or disposed or secured on the upper panel 46 and aligned with the pathway 47 of the upper panel 46 for selectively blocking or opening the pathway 47 of the upper panel 46. For example, when the filter member 43 is blocked and may no longer filter the water, or when the water may no longer flow through the filter member 43, the water may no longer flow through the apertures 44 of the partition 40 and may be forced to flow upwardly through the smaller space 42 and to flow upwardly through the pathway 47 of the upper panel 46, in order to actuate or to open the check valve 50 and for allowing the water to flow into the upper portion of the larger space 41 or the filtering chamber 38 of the carrier 20, and then to flow out through the outlet port 45 (FIG. 2) of the carrier 20.

The check valve 50 may include a signal generating device 51 for generating a signal to indicate that the filter member 43 has been blocked or when the filter member 43 may no longer filter the water. For example, the signal generating device 51 may be a protrusion 51 extended form the check valve 50 and extendible upwardly through a hole 48 of an upper wall or a cover 49 to indicate that the water has been forced to upwardly through the pathway 47 of the upper panel 46, and thus for allowing the filter member 43 to be cleaned or changed or replaced by the user right away or when required. The signal generating device 51 may also be a buzzer device, a light device or the like for generating a sound signal, a light signal, or the other warning signals.

A peripheral frame 53 is disposed or arranged or engaged on the upper portion of the compartment 31 or the walls 32, 33 of the carrier 20, and includes a peripheral flange 54 extended radially and inwardly therefrom for engaging with a dirt collecting means or device 6 which includes a receptacle 60 to be slidably engaged into the upper portion of the compartment 31 of the carrier 20 and to be slidably engaged with the peripheral flange 54 or the peripheral frame 53 with such as a frictional engagement for allowing the receptacle 60 to be moved or adjusted up and down relative to the compartment 31 of the carrier 20. The receptacle 60 is provided for receiving and collecting the bubbles and/or the dirt and/or the protein.

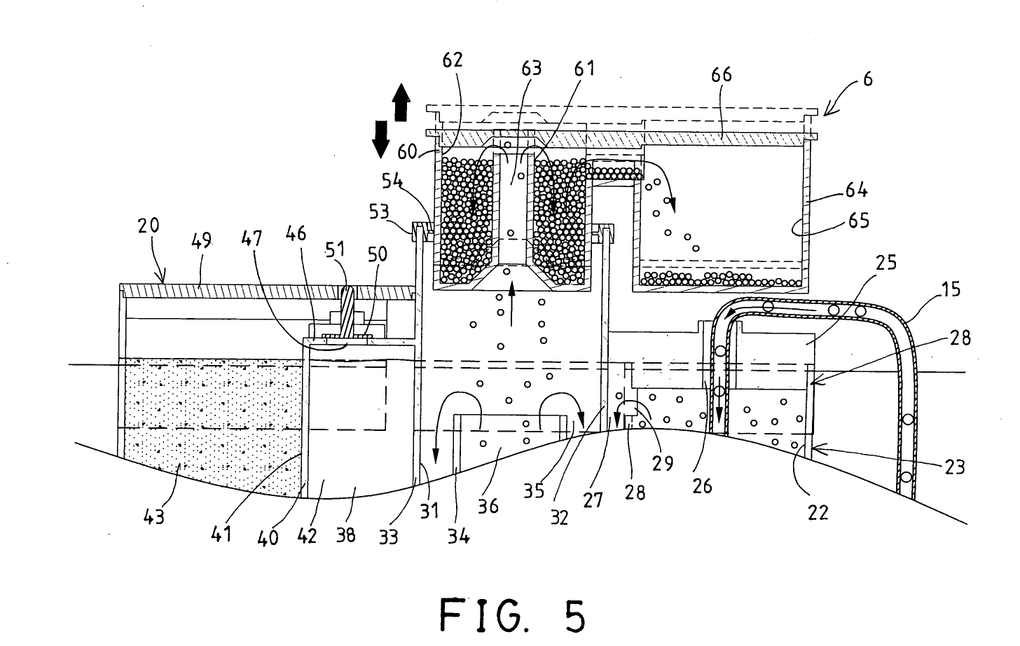

The receptacle 60 includes a tubular member 61 extended in such as receptacle 60 for forming an annular or peripheral space 62 between the tubular member 61 and the receptacle 60, and for forming a passageway 63 within the tubular member 61 and communicating with the compartment 31 of the carrier 20, and thus for receiving and collecting the bubbles and/or the dirt and/or the protein carried by the bubbles, and for allowing the bubbles and/or the dirt and/or the protein to flow upwardly beyond or over the tubular member 61 and to be received or collected within the annular chamber 62 of the receptacle 60. The receptacle 60 may include a casing 64 having a chamber 65 formed therein and communicating with the peripheral space 62 of the receptacle 60 for receiving and collecting the dirt and/or the protein carried by the bubbles (FIGS. 5-7).

A lid 66 may be attached to the upper portion of the receptacle 60 and/or the casing 64 for closing or blocking or sealing the upper portion of the receptacle 60 and/or the casing 64, and includes an orifice 68 formed therein for allowing the air in the environment to flow into the receptacle 60. The upper portion of the tubular member 61 is slightly lower than the upper portion of the receptacle 60 and/or slightly lower than the lid 66 for allowing the bubbles and/or the dirt and/or the protein to flow upwardly beyond or over the tubular member 61. The upwardly flowing bubbles may carry and move the dirt and/or the protein over the tubular member 61 for allowing the dirt and/or the protein to be collected in the peripheral space 62 of the receptacle 60.

In operation, as shown in FIGS. 5-6, the water in the aquarium 8 may be drawn into the lower or bottom portion of the inlet chamber 22 of the carrier 20 by the powered or motorized impeller 14, and then may flow upwardly through the inlet chamber 22 of the carrier 20 and to be filtered by the filtering material 24, the water may then flow through the notch 29 of the wall 28 to flow into the passage 27 of the carrier 20, and then to flow through the duct 37 and to flow into the lower portion of the barrel 34 and then to flow upwardly through the bore 36 of the barrel 34 and then to flow over the barrel 34 and then to flow into the peripheral space 35 of the carrier 20. The bubbles may flow upwardly through the passageway 63 of the tubular member 61 and may carry the dirt and/or the protein to move the dirt and/or the protein upwardly beyond or over the tubular member 61 and to be received or collected within the annular chamber 62 of the receptacle 60.

The water from the compartment 31 or the peripheral space 35 of the carrier 20 may flow through the opening 39 may flow into the filtering chamber 38 of the carrier 20, and then may flow through the apertures 44 of the partition 40 and then may flow upwardly through the larger space 41, and to be filtered by the filter member 43, and to flow out through the outlet port 45 of the carrier 20. When the filter member 43 is blocked and may no longer filter the water, or when the water may no longer flow through the filter member 43, the water may no longer flow through the apertures 44 of the partition 40 and may be forced to flow upwardly through the smaller space 42 and to flow upwardly through the pathway 47 of the upper panel 46, in order to actuate or to open the check valve 50, and the signal generating device 51 of the check valve 50 may generate a signal to indicate that the filter member 43 has been blocked or when the filter member 43 may no longer filter the water.

The check valve 50 and/or the signal generating device 51 of the check valve 50 may be formed or acted as a signal generating means for generating a signal to indicate that the filter member 43 has been blocked or when the filter member 43 may no longer filter the water, for allowing the filter member 43 to be cleaned or changed or replaced by the user right away or when required.

Accordingly, the air bubble collecting device in accordance with the present invention may be provided for attaching to an aquarium and for generating a signal to indicate that the filter members or devices have been blocked or when the filter members or devices may no longer filter the water contained within the container of the aquarium, and for allowing the filter members or devices to be cleaned or changed or replaced by the user when required.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A filtration device for an aquarium comprising:
a carrier for attaching to the aquarium and including a filtering chamber formed therein for receiving a water,
a filter member disposed in said filtering chamber for filtering the water, and
means for generating a signal to indicate whether said filter member has been blocked or not.

2. The filtration device as claimed in claim 1, wherein said carrier includes a pathway formed therein, said signal generating means includes a check valve for selectively blocking said pathway of said carrier and for being selectively actuated by the water to open said pathway of said carrier when said filter member is blocked.

3. The filtration device as claimed in claim 2, wherein said check valve includes a protrusion extended form said check valve.

4. The filtration device as claimed in claim 2, wherein said carrier includes a cover having a hole formed therein, and said protrusion is extendible through said hole of said cover.

5. The filtration device as claimed in claim 2, wherein said carrier includes an upper panel, and said pathway is formed in said upper panel of said carrier.

6. The filtration device as claimed in claim 5, wherein said carrier includes a partition disposed in said filtering chamber of said carrier for spacing said filtering chamber of said carrier into a first space and a second space, and said filter member is disposed in said first space of said carrier, said upper panel is disposed for closing said second space of said carrier.

7. The filtration device as claimed in claim 1, wherein said carrier includes a compartment formed therein and located beside said filtering chamber of said carrier and communicating with said filtering chamber of said carrier for receiving the water from said filtering chamber of said carrier.

8. The filtration device as claimed in claim 7, wherein said carrier includes a dirt collecting device provided on said compartment of the carrier for collecting a dirt.

9. The filtration device as claimed in claim 8, wherein said dirt collecting device includes a receptacle disposed on said compartment of the carrier for receiving bubbles from said filtering chamber of said carrier.

10. The filtration device as claimed in claim 9, wherein said receptacle includes a tubular member extended in said receptacle for forming a peripheral space between said tubular member and said receptacle, and for forming a passageway within said tubular member which is communicating with said compartment of said carrier for receiving the bubbles which carry the dirt for moving the dirt upwardly over said tubular member.

11. The filtration device as claimed in claim 10, wherein said receptacle includes a casing having a chamber formed therein and communicating with said peripheral space of said receptacle for receiving and collecting the dirt.

12. The filtration device as claimed in claim 9, wherein said carrier includes a peripheral frame disposed on said compartment of the carrier for slidably engaging with said receptacle.

13. The filtration device as claimed in claim 12, wherein said peripheral frame includes a peripheral flange extended inwardly from said peripheral frame for slidably engaging with said receptacle.

14. The filtration device as claimed in claim 7, wherein said carrier includes an inlet chamber formed therein, and a passage formed between said inlet chamber and said compartment of the carrier, and a barrel disposed in said compartment of the carrier and having a duct communicating said barrel with said passage of said carrier for allowing the water to flow from said inlet chamber into said barrel.

15. The filtration device as claimed in claim 14, wherein said carrier includes a filtering material disposed in said inlet chamber of said carrier, and a hose engaged into said inlet chamber of said carrier for supplying the water into said inlet chamber of said carrier.

16. The filtration device as claimed in claim 15, wherein an inlet member is coupled to said hose.

17. The filtration device as claimed in claim 15, wherein a pumping device is coupled to said hose for pumping the water into said hose.
